(19) United States
(12) Patent Application Publication
(10) Pub. No.: US 2009/0068622 A1
(43) Pub. Date: Mar. 12, 2009

(54) LETTER GUIDE SHEET

(75) Inventor: Toni M. Schulken, Charlotte, NC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Glenn Allen, VA (US)

(21) Appl. No.: 11/852,615

(22) Filed: Sep. 10, 2007

(51) Int. Cl. G09B 11/04

(52) U.S. Cl. 434/88

(57) ABSTRACT

A drawing sheet assembly including a plurality of drawing sheets, each drawing sheet including sequential instruction indicia. The instruction indicia instructs a user to draw at least part of two pre-writing shapes that cooperate to create a rudimentary drawing. Each drawing sheet further includes a drawing space providing a space in which a user can draw the rudimentary drawing in accordance with the sequential instruction indicia. The plurality of drawing sheets collectively include instruction indicia instructing a user to draw at least part of all nine pre-writing shapes.

The present invention is directed to a sheet for developing a user's writing instrument skills, more particularly, to a sheet for developing a user's pre-writing skills.

### BACKGROUND

The development of pre-writing shapes is important in developing proper writing and drawing skills. As children and other users learn to write letters and parts of letters, it is important to teach the proper form of the pre-writing shapes, as well as proper stroke direction (i.e. directionality of formation). Moreover, user should be taught continuity of pre-writing shape formation which results in increased legibility and leads to an easier transition to writing.

### SUMMARY

In one embodiment the invention is drawing sheet assembly including a plurality of drawing sheets, each drawing sheet including sequential instruction indicia. The instruction indicia instructs a user to draw at least part of two pre-writing shapes that cooperate to create a rudimentary drawing. Each drawing sheet further includes a drawing space providing a space in which a user can draw the rudimentary drawing in accordance with the sequential instruction indicia. The plurality of drawing sheets collectively include instruction indicia instructing a user to draw at least part of all nine pre-writing shapes.

### BRIEF DESCRIPTION OF THE DRAWINGS

FIG. 1 illustrates the nine pre-writing shapes;

FIG. 2 illustrates an instruction sheet teaching a user how to draw some of the pre-writing shapes;

FIG. 3 is another instruction sheet teaching a user how to draw the remaining pre-writing shapes;

FIG. 4 is a drawing sheet with indicia to teach a user how to create a drawing;

FIG. 5 is another drawing sheet with indicia to teach a user how to create a drawing; and

FIG. 6 is another drawing sheet with indicia to teach a user how to create a drawing.

### DETAILED DESCRIPTION

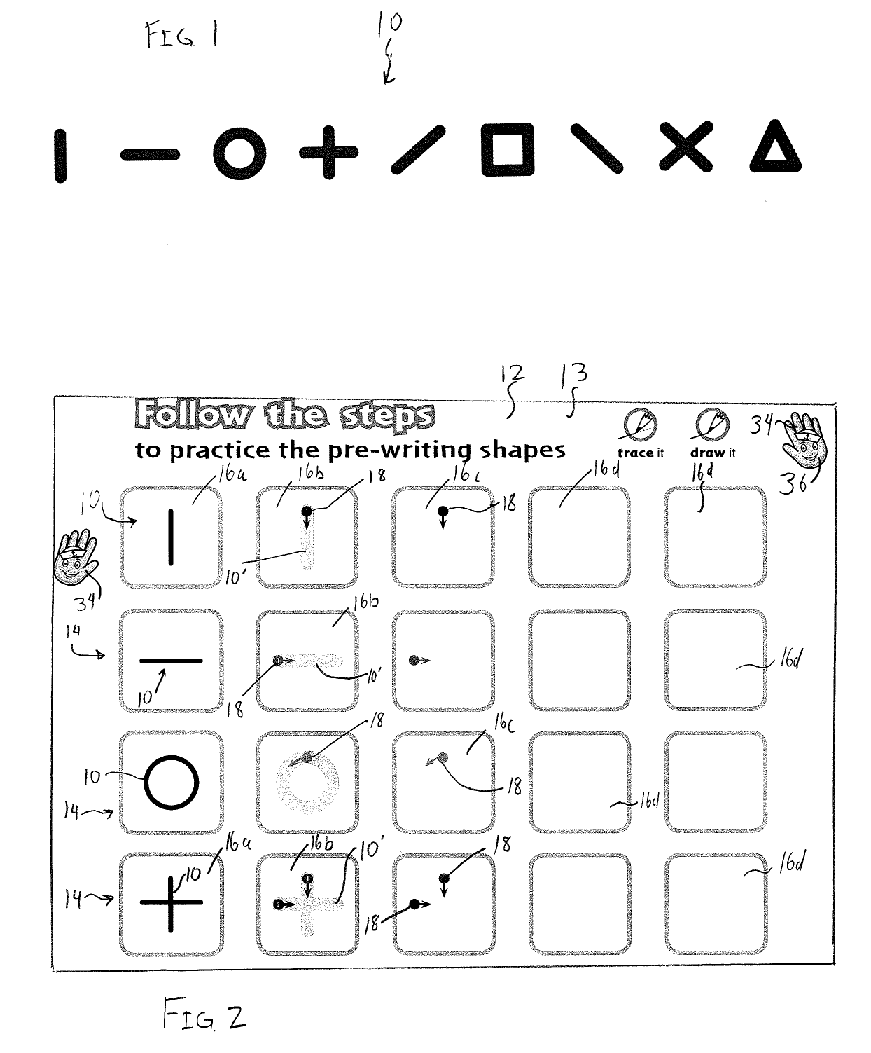

The development of pre-writing shapes is important in developing proper writing and drawing skills. In particular, the nine pre-writing shapes 10 shown in FIG. 1 consist of a vertical line, a horizontal line, a circle, a cross (also known more specifically as a horizontal and vertical cross), a right oblique, a square, a left oblique, an “X” (also known more specifically as an oblique cross), and a triangle. These pre-writing shapes 10 can be arranged to create all of the capital letters of the English alphabet (or the Latin alphabet) and therefore are important building blocks for a user to learn for proper capital letter formation.

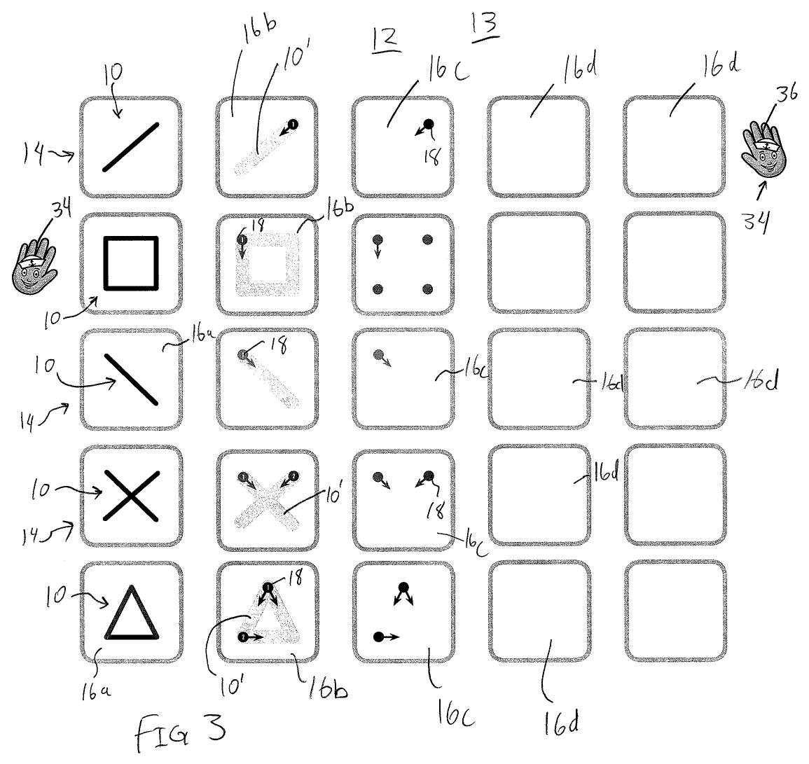

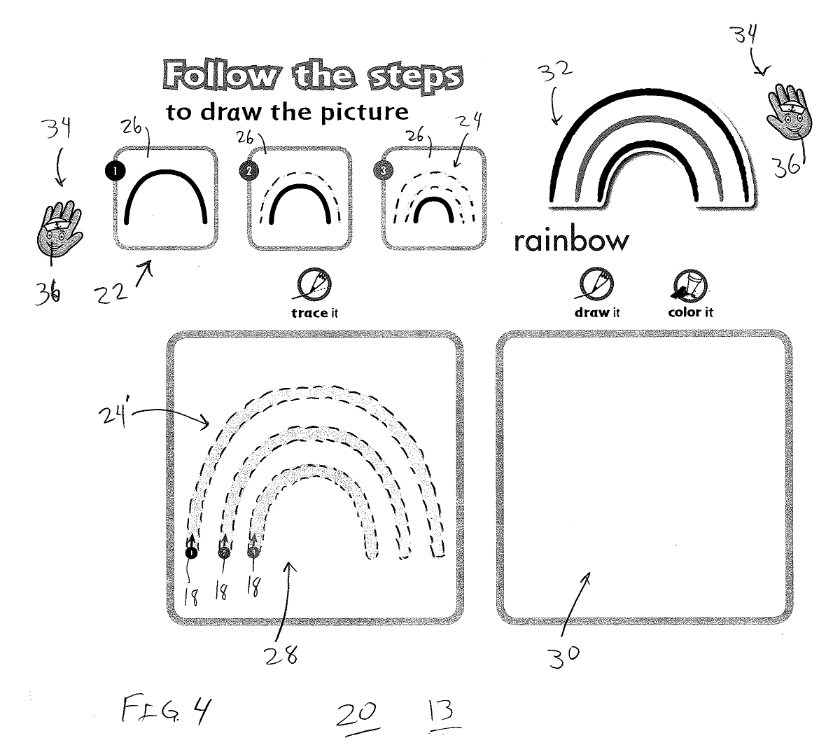

As shown in FIGS. 2 and 3, instruction sheets 12 may be provided that instruct a user in the proper strokes for drawing the pre-writing shapes 10. Each instruction sheet 12 may include or be made of a sheet-like portion or piece of sheet-like material 13. The instruction sheets 12/sheet-like portions 13 can be made of from any of a wide variety of materials but will typically be made of a cellulose-base or pulp-base paper such that the sheets 12 are generally water absorbent and can be written upon by a wide variety of media (i.e. pens, pencils, markers, crayons, etc.) However, the sheets 12 can be made of any of a relatively wide variety of materials, and need not necessarily be of a water-absorbent material (i.e. could be a write-on/wipe off (polymer) material that can be re-used, etc.) The instruction sheets 12 may be relatively thin, and may have a thickness of about 0.5 mm or less.

Each instruction sheet 12 may include a plurality of horizontally-oriented instruction rows 14, which each row 14 being associated with one of the pre-writing shapes 10. Each row 14 may include a plurality of blocks or spaces 16 that present the associated pre-writing shape 10, and teach the user how to draw the associated pre-writing shape 10. For example, the first block 16 of each row 14 may be a presentation block 16a which presents the pre-writing shape 10.

The next block 16 (in a left-to-right progression) of each row 14 may be an instruction block 16b which presents the pre-writing shape 10 in a traceable format 10′, along with guide arrows 18 (i.e. directional cues) to show the proper writing strokes to draw each pre-writing shape 10. Each traceable pre-writing shape 10′ in each instruction block 16b may be traceable in that it is presented as a relatively thin or light line, a shaded line, a non-black line (the line may be gray, however) and/or an incomplete line which is printed in dotted or dashed format. This allows a user to draw over the traceable pre-writing shape 10′ while easily distinguishing which portions of the traceable version 10′ are pre-printed, and which portions have been drawn by the user.

Each guide arrow 18 may be positioned on top of the associated traceable versions 10′, or may be positioned immediately adjacent thereto. Each guide arrow 18 cues the user as to the starting point of a writing stroke, as well at the direction of the stroke. In the illustrated embodiment, each guide arrow 18 of each instruction block 16b may be numbered, and may also be colored (i.e. a non-white and non-black color, such as red, orange, green, blue, purple, etc.) Each arrow 18 may have a unique color relative to other arrows in that instruction block 16b. For example in the lower instruction block 16b of FIG. 2 illustrating a cross, the arrow numbered “1” may be blue and the arrow numbered “2” may be purple. Drawing over the traceable version 10′ of the pre-writing shape in accordance with the directional cues 18 encourages a user to learn proper directional sequence for writing and pre-writing skills (i.e. top-to-bottom; left-to-right; continuous strokes, top-to-left (i.e. counterclockwise from the top) for curves, etc.) The next blocks 16 (in a left-to-right progression) are cue blocks 16c. In the cue blocks 16c the guide arrows 18 are presented, but the traceable version 10′ of the associated pre-writing shape 10 is not included, and the arrows 18 are not numbered. Thus the cue blocks 16c encourage a user to draw the pre-writing shape 10 with reduced guidance. The arrows 18 in the cue blocks 16c may be colored according to the coloring scheme of the associated instruction block 16b. For example, in the bottom cue block 16c of FIG. 2 the vertical arrow may be blue, and the horizontal arrow may be purple.

Finally, blank blocks 16d may provided adjacent to the cue blocks 16c of each row 14. In this manner, as a user works left-to-right across a row 14, the user receives progressively less instructions to allow a user to learn how to draw each pre-writing shape 10 without direct guidance. In addition, each row 14 provides numerous opportunities for a user to draw each pre-writing shape 10 to learn by repetition.

Each block 16 may be generally square and each can be generally the same size, although the size, shape and position of the blocks 16 may vary as desired. Each block 16 (except, in one case, the presentation blocks 16a) may be filled with a yellow color to attract the attention of the user. The yellow color also decreases visual fatigue, which can be particularly useful with children who are not used to working with paper for long periods of time. A yellow fill color in the boxes 16 is also easy to write upon and provides sufficient contrast with pencils and other writing instruments. However, various other fill colors besides yellow, such as rose, light blue or the like may be utilized in the blocks 16.

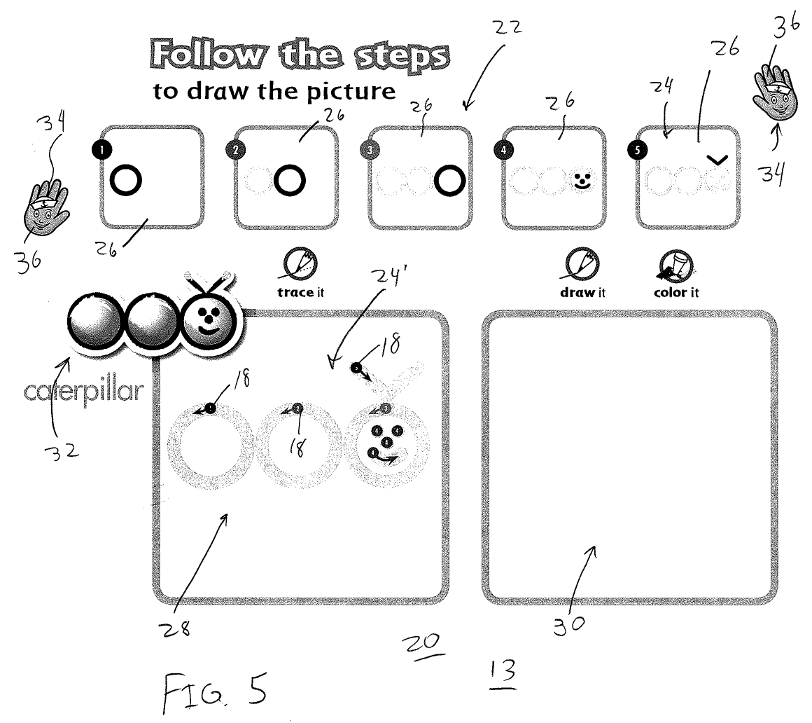

As shown in FIGS. 4-6, a plurality of drawing sheets 20 may be provided with, or coupled to, the instruction sheets 12. Each drawing sheet 20 may be made of the same materials as the drawing sheets 12/sheet-like material 13 as described above. Each drawing sheet 20 includes a series of sequential instruction indicia 22 printed thereon to instruct the user to draw two or more pre-writing shapes 10, or parts thereof, to create a rudimentary drawing 24.

For example, in the embodiment of FIG. 3, three circle segments, which are part of the circle pre-writing shape 10, are drawn to provide a rainbow drawing 24. In the illustrated embodiment, the sequential instruction indicia 22 illustrates, in a series of blocks or steps 26, the drawing strokes required to create the rudimentary drawing 24. Each block 26 illustrates the required drawing stroke in a bold line, and the subsequent blocks 26 illustrate the previous drawing strokes in a lighter, thinner, or less prominent form (i.e. similar to the traceable lines described above) to emphasize the current drawing stroke required in that block 26. However, the current/previous drawing lines can be distinguished by nearly any property, such as color, shading, patterns, etc.

Each block 26 may be identified by a number, and each number or block may be printed in or otherwise associated with a color. For example in FIG. 4, block 26 associated with the number “1” (i.e. the border, associated number, shading or the like of the block 26) may be red, block 26 associated with the number “2” may be orange and block 26 associated with the number “3” may be green.

Each drawing sheet 20 may include a tracing area 28 which includes the rudimentary drawing 24 in a traceable version or format 24′. Each line in the traceable version 24′ may be lightened, dotted, etc as described above in the context of the instruction blocks 16b of the instruction sheets 12. The tracing area 28 may have arrows 18 that guide the user in the proper line strokes and order for creating the rudimentary drawing. Moreover, each arrow 18 may be color coded to match the associated instruction block 26. For example, arrow “1” in the tracing area 28 of FIG. 4 may be red (to emphasize that the associated stroke corresponds to block 1 of the instruction indicia 22), arrow “2” may be orange and arrow “3” may be green.

However, it should be noted that besides color coding of the arrows, blocks and steps, various other patterns, indicia or the like may be utilized to associate those components. This can be useful in cases where color printing is not desired or practicable, or to accommodate users with color blindness.

Each drawing sheet 20 may include a drawing areas 30 which can be a block or defined space in which the user is encouraged to draw the rudimentary drawing 24. In this case, when using the drawing sheet 20 the user is encouraged or instructed to first trace the rudimentary drawing 24 in the tracing area 28, and then draw the rudimentary drawing 24 in the drawing space 30. The drawing space 30 and tracing area 28 may each be filled with a yellow or other fill colors (described above in conjunction with the blocks 16 of the instruction sheets 12) to provide the same advantages described above.

Each sheet 12 may also include an illustrated drawing and associated text 32 (i.e. a drawing of a rainbow and the text “rainbow”) printed thereon which corresponds to the associated rudimentary drawing 24. The illustrated drawing 32 may be more complex and provides a more aesthetically pleasing appearance than the rudimentary drawing 24 to capture the interest of a user. The illustrated drawing and text 32 also helps a user to further identify and create the rudimentary drawing 24.

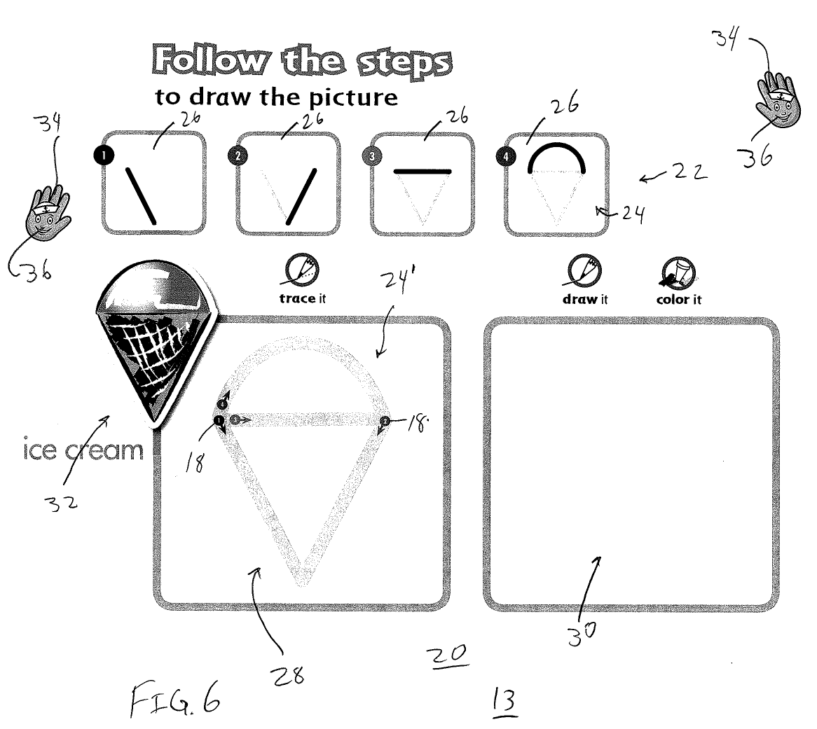

The embodiment of FIG. 3 present a basic rudimentary shape in the form of a rainbow which utilizes only part of a single pre-writing shape 10 duplicated three times. As a user develops, more and more pre-writing shapes 10, and parts thereof, can be utilized. For example, the rudimentary shape 24 of FIG. 5 incorporates three circles, three dots, a “v” shape and a circle segment to create a representation of a caterpillar with a face. In the embodiment shown in FIG. 6, the rudimentary shape 24 includes a semi-circle positioned on top of a triangle to create a representation of an ice cream cone. Thus at least two or more pre-writing shapes 10 (or parts thereof) may be positioned immediately adjacent to each other, and cooperate together, to create rudimentary drawings 24 of increasing complexity.

The instruction sheets 12 shown in FIGS. 2 and 3 may be packaged with the drawing sheets 20 of FIGS. 4-6, along with a plurality of additional drawing sheets 20 (i.e. may be bound thereto as part of a drawing pad or the like) of the same basic format but having varying instruction indicia, traceable drawings and illustrated drawings. The entire drawing sheet assembly may thereby include a wide variety of rudimentary drawings 24 created with the nine pre-writing shapes 10 arranged in differing manners and in increasing complexity. In this manner, a purchaser of the pad can ensure that the user will learn all nine pre-writing shapes 10 by using the associated drawing sheets 20 in the pad.

Each instruction sheet 12 and/or drawing sheet 20 may include or carry thereon at least one hand cue 34 upon which a user can place his or her hand to manually stabilize the associated sheet 12/20 (particularly when the sheet 12/20 is separated from a pad and used alone). Each hand cue 34 may include or take the form of a visual cue 36. In the illustrated embodiment, the visual cue 36 takes the form of a visual representation (i.e. drawing, design, photograph or the like) of a hand to cue or encourage a user to place his or her hand on the hand cue 34. However, the visual cue 36 can take the form of other indicia besides a hand. For example some other indicia 36 (by way of example, a star, or the letter “H,” although nearly any sort of indicia can be used) may be provided on the sheet 12/20. A user may be taught (i.e. by the sheet 12/20, associated instructions/packaging, by a teacher, or parent, etc.) that the indicia 36 is to be associated with hand stabilization. In this case, when a user sees the visual cue 36 the user is prompted to stabilize the drawing sheet with his or her non-dominant (i.e. non-writing) hand.

Teachers typically have difficulty ensuring that their students properly stabilize their sheets 12/20 during use. Accordingly, the hand cues 34 serve as a constant reminder to the user to encourage proper stabilization and use of the sheets 12/20.

Each hand cue 34 may be positioned at or adjacent to the outer perimeter of the drawing sheet 12/20 to ensure proper hand placement. In particular, encouraging a user to place his or her stabilization hand at or adjacent to the outer edge of the drawing sheet 12/20 ensures that maximum stabilization force is exerted while ensuring that the stabilization hand does not interfere with writing operations on the drawing sheet 12. Thus, at least part of each hand cue 34 may be located within about 3 inches of the outer edge of the drawing sheet 12, or within about 10% or 20% of the height or width of the drawing sheet 12 of the outer edge. Each hand cue 34 may be relatively small, and, for example, cover less than about 10%, or less than about 5%, of the surface area of the associated sheet 12/20.

The drawing sheet 12/20 may include a hand cue 34 on both the left and right sides of the drawing sheet 12/20 (with the “left” and “right” orientation being taken from the perspective of a user reading the drawing sheet 12/20 as shown in the figures). The use of two opposed hand cues 34 ensures that a hand cue 34 is sufficiently presented and available for both left-handed and right-handed users. Both hand cues 34 may be located in the upper half of the drawing sheet 12/20 since stabilization in the upper half of the sheet 12/20 is most effective and allows full access to the drawing sheet. Moreover, the hand cue 34 on the left side of the sheet 12/20 (utilized by right-handed users) is positioned below the hand cue on the right side of the sheet 12/20 (utilized by left-handed users). Due to the layout of most drawing sheets, as well as orientation of writing desks, etc. it is desired to place the hand cue 34 for left-handed users higher on the sheet 12/20 than the other hand cue 34.

The drawing sheet 12/20 may be packaged for sale along with a set of instructions that instruct a user (or a user's parents, teachers, etc.) to use the sheets 12/20 in the manner described herein, or the instructions can be printed on the sheet 12/20.

Proper writing habits includes making vertical and diagonal lines from top-to-bottom, making circles from the top and drawing counterclockwise toward the left, and making horizontal lines from left-to-right. Teaching a user to develop these habits prepares a child for proper letter writing. Moreover, learning to follow a visual sequence is important in learning to follow multi-step directions. In addition learning a particular sequence in shape and letter writing can increase legibility and writing fluency (speed and accuracy).

Finally, learning to use various lines and curves to construct an object, especially learning to use continuous strokes (rather than unnecessarily lifting the writing instrument) further aides the user in the development of the underlying skills needed for proper letter formation and drawing skills. Thus the sheets 12/20 teach a user various useful skills for writing skill development.

Thus the sheets 12/20 encourage a user to develop visual motor control skills (eye-hand coordination), visual motor integration skills, sequencing skills (by following the sequenced instructions), visual discrimination skills (by noting differences from one instruction to the next), visual closure skills (by determining where to add the next part or line of the drawing), bilateral coordination (by using both hands), visual closure skills (recognizing what the picture is before it is completed), and visual spatial relationships (determining what orientation to place the next line or part of drawing).

Having described the invention in detail and by reference to the various embodiments, it should be understood that modifications and variations thereof are possible without departing from the scope of the invention.

What is claimed is:

1. A drawing sheet assembly comprising:
a plurality of drawing sheets, each drawing sheet including;
sequential instruction indicia instructing a user to draw at least part of two pre-writing shapes that cooperate to create a rudimentary drawing; and
a drawing space providing a space in which a user can draw said rudimentary drawing in accordance with said sequential instruction indicia, wherein said plurality of drawing sheets collectively include instruction indicia instructing a user to draw at least part of all nine pre-writing shapes.

2. The drawing sheet assembly of claim 1 wherein said plurality of drawing sheets collectively include instruction indicia instructing a user to draw the complete form of all nine pre-writing shapes.

3. The drawing sheet assembly of claim 1 wherein said nine pre-writing shapes include the basic shapes required to write all the capital letters of the English alphabet, and comprise a vertical line, a horizontal line, a circle, a cross, a right oblique, a square, a left oblique, an oblique cross, and a triangle.

4. The drawing sheet assembly of claim 1 wherein each drawing sheet includes an illustrative drawing printed thereon, said illustrative drawing corresponding in general shape to the associated rudimentary drawing but being more complex than the associated rudimentary drawing.

5. The drawing sheet assembly of claim 1 wherein each drawing sheet further includes a traceable version of said rudimentary drawing

6. The drawing sheet assembly of claim 5 wherein said traceable version of said rudimentary drawing is made of relatively light or non-black or incomplete lines forming the same general shape as said rudimentary drawing.

7. The drawing sheet assembly of claim 5 wherein each drawing sheet further includes directional cues positioned on said traceable version or positioned immediately adjacent thereto to guide a user writing over said traceable version.

8. The drawing sheet assembly of claim 7 wherein said directional cues are color coded or numerically coded to said instruction indicia.

9. The drawing sheet assembly of claim 1 wherein each drawing sheet includes a hand cue for cuing a user to place the user's hand thereon to manually stabilize the associated drawing sheet during use.

10. The drawing sheet assembly of claim 9 wherein said hand cue includes a representation of a hand.

11. The drawing sheet assembly of claim 9 wherein said hand cue is positioned at or adjacent to an outer perimeter of the associated sheet.

12. The drawing sheet assembly of claim 9 further comprising a supplemental hand cue on each drawing sheet, and wherein each drawing sheet has printing thereon that is designed to be read when said drawing sheet is in a particular orientation, and wherein said hand cue is located adjacent to a left edge and said supplemental hand cue is located adjacent to a right edge when said drawing sheet is in said particular orientation.

13. The drawing sheet assembly of claim 1 wherein said sequential instruction indicia includes a set of progressive illustrations showing how to draw said at least part of said two pre-writing shapes.

14. The drawing sheet assembly of claim 1 further comprising pre-writing shape indicia instructing how to draw all nine pre-writing shapes by themselves.

15. The drawing sheet assembly of claim 14 wherein said pre-writing shape indicia includes color coded cues and a traceable version of each pre-writing shape.

16. The drawing sheet assembly of claim 1 wherein each sheet is bound together to form a single assembly in which all nine pre-writing shapes are taught.

17. A method for using drawing sheet assembly comprising:
accessing a drawing sheet assembly including a plurality of drawing sheets, each drawing sheet including sequential instruction indicia printed thereon;
drawing at least part of two pre-writing shapes on a selected one of said drawing sheets in accordance with the sequential instructions such that the at least two pre-writing shapes cooperate to create rudimentary drawing; and
repeating said drawing step until rudimentary drawings utilizing all nine of the pre-writing shapes are created.

18. The method of claim 17 wherein said repeating step includes utilizing differing ones of said drawing sheets.

19. A sheet assembly comprising:
a piece of sheet-like material;
a hand cue on said piece of sheet-like material for cuing a user to place the user's hand thereon to manually stabilize the piece of sheet-like material during use; and
instruction indicia printed on, coupled to, or packaged with said piece of sheet-like material, said instruction indicia instructing a user to place their hand on said hand cue to manually stabilize said piece of sheet-like material during use.

20. The sheet assembly of claim 19 wherein said hand cue includes a representation of a hand.

21. The sheet assembly of claim 19 wherein said hand cue is positioned at or adjacent to an outer perimeter of the piece of sheet-like material.

22. The sheet assembly of claim 19 further comprising a supplemental hand cue on said piece of sheet-like material, and wherein said piece of sheet-like material has printing thereon that is designed to be read when said piece of sheet-like material is in a particular orientation, and wherein said hand cue is located adjacent to a left edge and said supplemental hand cue is located adjacent to a right edge when said piece of sheet-like material is in said particular orientation.

23. The sheet assembly of claim 22 wherein said hand cue located adjacent to said left edge is positioned at a lower height than said hand cue located adjacent to said right edge when said piece of sheet-like material is in said particular orientation.

24. The sheet assembly of claim 19 wherein said piece of sheet-like material is piece of cellulose-based paper.

25. The sheet assembly of claim 19 wherein said hand cue covers less than about 10% of the surface area of said piece of sheet-like material.
